(19) United States
(12) Patent Application Publication
(10) Pub. No.: US 2025/0282482 A1
(43) Pub. Date: Sep. 11, 2025

(54) ENVIRONMENTAL CONTROL SYSTEM USING ARCHITECTURE WITH DUAL ENTRY TURBINE

(71) Applicant: Hamilton Sundstrand Corporation, Charlotte, NC (US)

(72) Inventors: Louis J. Bruno, Ellington, CT (US); Aiden Coutin, Ogden, UT (US)

(21) Appl. No.: 18/978,721

(22) Filed: Dec. 12, 2024

Related U.S. Application Data
(60) Provisional application No. 63/563,573, filed on Mar. 11, 2024.

(51) Int. Cl. B64D 13/08; B64D 13/06; F02C 6/08

(52) U.S. Cl. CPC B64D 13/08; F02C 6/08; B64D 2013/0603; B64D 2013/0618

(57) ABSTRACT

An environmental control system of a vehicle includes a first inlet for providing a first medium, a second inlet for providing a second medium. The second medium is different than the first medium. A thermodynamic device is fluidly connected to the first and second inlets. The thermodynamic device includes a compressor and at least one turbine operably coupled by a shaft. The environmental control system is operable in a plurality of modes, and in a first mode of the plurality of modes, the thermodynamic device is driven solely by energy extracted from the first medium.

### CROSS-REFERENCE TO RELATED APPLICATIONS

This application claims the benefit of U.S. Application No. 63/563,573 filed Mar. 11, 2024, the contents of which are incorporated by reference herein in its entirety.

### BACKGROUND

Embodiments of the disclosure relate to environmental control systems, and more specifically to an environmental control system of an aircraft.

In general, contemporary air condition systems are supplied a pressure at cruise that is approximately 30 psig to 35 psig. The trend in the aerospace industry today is towards systems with higher efficiency. One approach to improve airplane efficiency is to eliminate the bleed air entirely and use electrical power to compress outside air. A second approach is to use lower engine pressure. The third approach is to use the energy in the bleed air to compress outside air and bring it into the cabin. Unfortunately, each of these approaches provides limited efficiency with respect to engine fuel burn.

### BRIEF DESCRIPTION

According to an embodiment, an environmental control system of a vehicle includes a first inlet for providing a first medium, a second inlet for providing a second medium. The second medium is different than the first medium. A thermodynamic device is fluidly connected to the first and second inlets. The thermodynamic device includes a compressor and at least one turbine operably coupled by a shaft. The environmental control system is operable in a plurality of modes, and in a first mode of the plurality of modes, the thermodynamic device is driven solely by energy extracted from the first medium.

In addition to one or more of the features described above, or as an alternative, in further embodiments the compressor is fluidly connected to and arranged downstream from the second inlet.

In addition to one or more of the features described above, or as an alternative, in further embodiments the first medium is bleed air.

In addition to one or more of the features described above, or as an alternative, in further embodiments the second medium is fresh air.

In addition to one or more of the features described above, or as an alternative, in further embodiments the thermodynamic device includes a fan operably coupled to the shaft and in the first mode and the compressor and the fan are driven by the energy extracted from the first medium.

In addition to one or more of the features described above, or as an alternative, in further embodiments the at least one turbine includes a first turbine and a second turbine. The first turbine is fluidly coupled to both the first inlet and the second inlet and the second turbine is fluidly connected to the first inlet.

In addition to one or more of the features described above, or as an alternative, in further embodiments the first turbine is arranged downstream from the compressor relative to a flow of the second medium.

In addition to one or more of the features described above, or as an alternative, in further embodiments a first valve is operable to direct a flow of the first medium from an outlet of the first inlet toward either the first turbine or the second turbine and a second valve is operable to direct a flow of the second medium into a bypass conduit positioned to bypass the first turbine.

In addition to one or more of the features described above, or as an alternative, in further embodiments in the first mode, only the second medium is provided to an outlet of the environmental control system.

In addition to one or more of the features described above, or as an alternative, in further embodiments the environmental control system includes a ram air circuit having a ram air duct and at least one heat exchanger arranged within the ram air duct.

In addition to one or more of the features described above, or as an alternative, in further embodiments the at least one heat exchanger includes a first heat exchanger and a second heat exchanger and the first heat exchanger and the second heat exchanger being arranged in series relative to a flow of ram air within the ram air duct.

In addition to one or more of the features described above, or as an alternative, in further embodiments the at least one heat exchanger includes a first heat exchanger and a second heat exchanger, the first heat exchanger and the second heat exchanger being arranged in parallel relative to a flow of ram air within the ram air duct.

According to an embodiment, an environmental control system of a vehicle includes a first inlet for providing a first medium and a second inlet for providing a second medium. The second medium is different than the first medium. A thermodynamic device is fluidly connected to the first and second inlets. The thermodynamic device includes a compressor and at least one turbine operably coupled by a shaft. The environmental control system is operable in a plurality of modes, and in a first mode of the plurality of modes, the thermodynamic device is driven solely by energy extracted at the first turbine and in the second mode, the thermodynamic device is driven solely by energy extracted at the second turbine.

In addition to one or more of the features described above, or as an alternative, in further embodiments the first medium is bleed air and the second medium is fresh air.

In addition to one or more of the features described above, or as an alternative, in further embodiments in the first mode, the thermodynamic device is driven by the energy extracted from the first medium and the second medium at the first turbine.

In addition to one or more of the features described above, or as an alternative, in further embodiments in the second mode, the thermodynamic device is driven by the energy extracted from the first medium at the second turbine.

According to an embodiment, a method of operating an environmental control system of an aircraft includes providing a first medium and a second medium to a thermodynamic device including a compressor and at least one turbine and in a first mode of operation includes extracting work from the first medium at the at least one turbine and compressing the second medium at the compressor. In at least one mode of operation, the compressor is driven only by work extracted from the first medium at the at least one turbine.

In addition to one or more of the features described above, or as an alternative, in further embodiments a second mode of operation includes extracting work from the first medium and the second medium at the at least one turbine.

In addition to one or more of the features described above, or as an alternative, in further embodiments the at least one turbine includes a first turbine and a second turbine. The first mode of operation includes extracting work from the first medium at the first turbine and the second mode of operation includes extracting work from the first medium and the second medium at the second turbine.

In addition to one or more of the features described above, or as an alternative, in further embodiments the first medium is bleed air and the second medium is fresh air.

### BRIEF DESCRIPTION OF THE DRAWINGS

The subject matter is particularly pointed out and distinctly claimed in the claims at the conclusion of the specification. The forgoing and other features, and advantages thereof are apparent from the following detailed description taken in conjunction with the accompanying drawings in which:

FIG. 1 is a schematic diagram of an environmental control system pack according to an embodiment;

FIG. 2 is a schematic diagram of the ECS pack of FIG. 1 in a ground mode of operation according to an embodiment;

FIG. 3 is a schematic diagram of the ECS pack of FIG. 1 in a high-altitude mode of operation according to another embodiment;

FIG. 4 is a schematic diagram of the ECS pack of FIG. 1 in a single pack mode of operation according to yet another embodiment;

FIG. 5 is a schematic diagram of an environmental control system pack according to an embodiment; and

FIG. 6 is a schematic diagram of an environmental control system pack according to another embodiment.

### DETAILED DESCRIPTION

A detailed description of one or more embodiments of the disclosed apparatus and method are presented herein by way of exemplification and not limitation with reference to the FIGS.

Embodiments herein provide an environmental control system of an aircraft that receives multiple mediums from different sources and uses energy from one or more of the mediums to operate the environmental control system and to provide cabin pressurization and cooling at a high fuel burn efficiency. The mediums described herein are generally types of air; however, it should be understood that other mediums, such as gases, liquids, fluidized solids, or slurries are also contemplated herein.

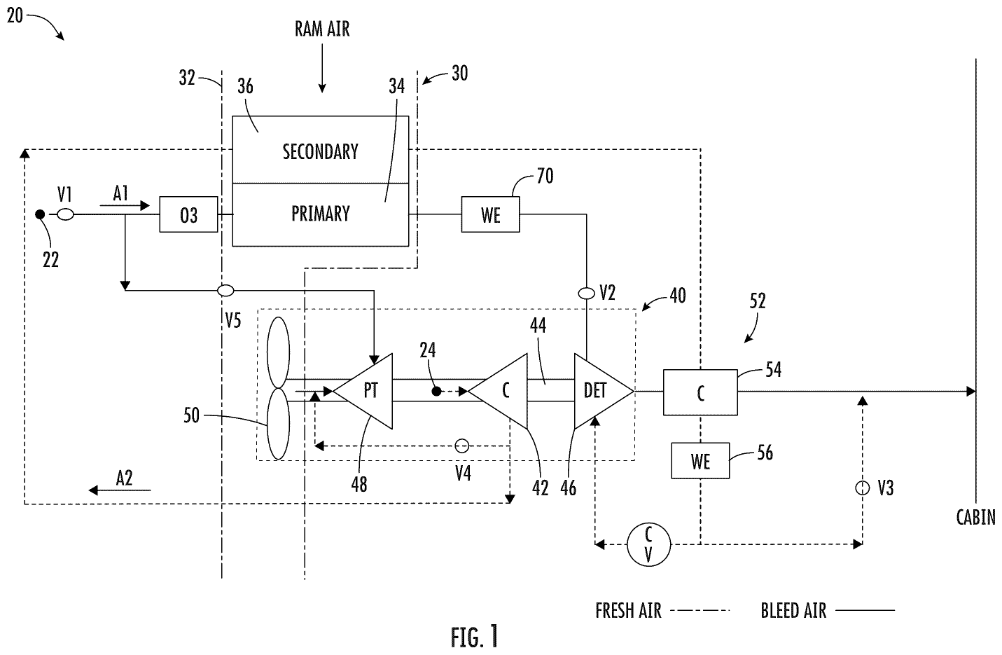

With reference now to the FIGS. 1, 5 and 6, various examples of a schematic diagram of a portion of an environment control system (ECS) 20, such as an air conditioning unit or pack for example, is depicted according to a non-limiting embodiment. Although the environmental control system or ECS pack 20 is described with reference to an aircraft, alternative applications, such as another vehicle for example, are also within the scope of the disclosure. As shown in each illustrated embodiment, the ECS 20 may be configured to receive a first medium A1 at a first inlet 22. In embodiments where the ECS 20 is used in an aircraft application, the first medium A1 is bleed air, which is pressurized air originating from, i.e., being “bled” from, an engine or auxiliary power unit of the aircraft. It shall be understood that one or more of the temperature, humidity, and pressure of the bleed air can vary based upon the compressor stage and revolutions per minute of the engine or auxiliary power unit from which the air is drawn.

The ECS 20 may alternatively or additionally be configured to receive a second medium A2 at a second inlet 24. In an embodiment, the second medium A2 is fresh air, such as outside air for example. The outside air can be procured via one or more scooping mechanisms, such as an impact scoop or a flush scoop for example. Thus, the second inlet 24 can be considered a fresh or outside air inlet. In an embodiment, the second medium A2 is ram air drawn from a portion of a ram air circuit. Generally, the second medium A2 described herein is at an ambient pressure equal to an air pressure outside of the aircraft when the aircraft is on the ground and is between an ambient pressure and a cabin pressure when the aircraft is in flight.

As shown, the ECS 20 may include a ram air circuit 30 including a shell or duct 32 within which one or more heat exchangers are located. The ram air duct 32 can receive and direct a medium, such as ram air for example, through a portion of the ECS 20. The one or more heat exchangers are devices built for efficient heat transfer from one medium to another. Examples of the type of heat exchangers that may be used, include, but are not limited to, double pipe, shell and tube, plate, plate and shell, adiabatic shell, plate fin, pillow plate, and fluid heat exchangers.

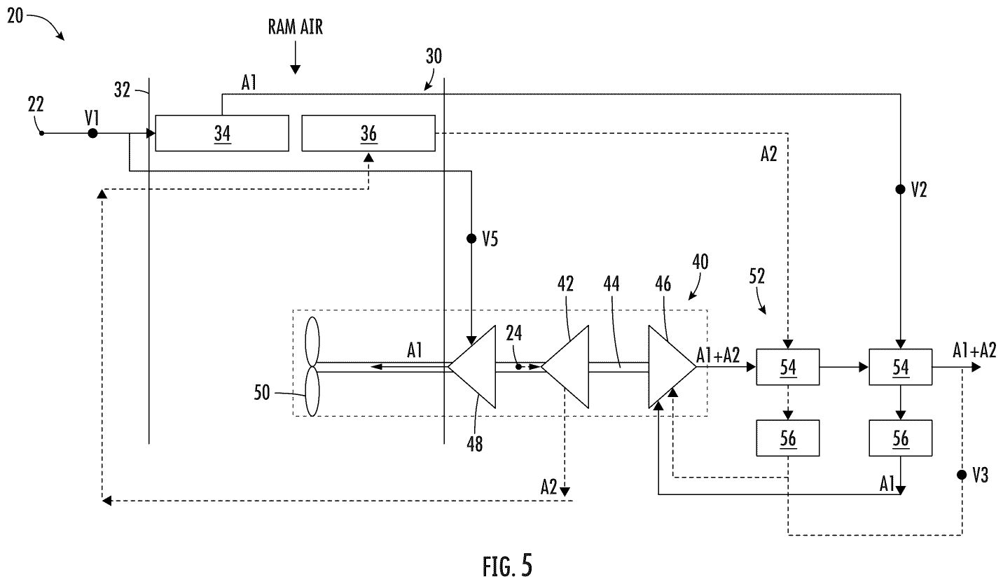

The one or more heat exchangers arranged within the ram air duct 32 may be referred to as ram air heat exchangers. In the illustrated, non-limiting embodiment, the at least one heat exchanger includes a first or first heat exchanger 34 and a second or second heat exchanger 36. Within the heat exchangers 34, 36, ram air, such as outside air for example, acts as a heat sink to cool a medium passing there through, for example the first medium A1 and/or the second medium A2. Although a ram air circuit 30 having only two heat exchangers 34, 36 is illustrated, it should be understood that embodiments having only a single heat exchanger, or alternatively, more than two heat exchangers are also contemplated herein. Further, although the heat exchangers 34, 36 are illustrated as being arranged in series relative to a flow of ram air through the ram air duct 32, it should be understood that in other embodiments, a plurality of heat exchangers, such as the primary and secondary heat exchangers 34, 36 for example, may be arranged in parallel relative to the flow of ram air (see FIG. 5).

The ECS 20 additionally includes at least one thermodynamic device 40, and in some embodiments includes a plurality of thermodynamic devices. Each thermodynamic device 40 is a mechanical device that includes components for performing thermodynamic work on a medium (e.g., extracts work from or applies work to the first medium A1, the second medium A2 by raising and/or lowering pressure and by raising and/or lowering temperature). Examples of a thermodynamic device include an air cycle machine, a two-wheel air cycle machine, a three-wheel air cycle machine, a four-wheel air cycle machine, etc.

In the illustrated, non-limiting embodiments, the ECS 20 includes a single thermodynamic device 40. However, embodiments including more than one thermodynamic device are also contemplated herein. The thermodynamic device 40 may include a compressor 42 and at least one turbine operably coupled by a shaft 44. In an embodiment, the thermodynamic device 40 includes a first turbine 46 and a second turbine 48. In such embodiments, the first medium A1 and/or the second medium A2 may be configured to flow through one or more the plurality of turbines 46, 48 based on a mode of operation. Further, a single medium may be provided to each of the turbines. However, in an embodiment, at least one of the plurality of turbines, such as turbine 46 for example, is a dual entry turbine that includes multiple fluid flow paths, such as an inner flow path and an outer flow path, to enable mixing of multiple medium flows within the turbine or at the exit of the turbine 46. In an embodiment, the inner flow path is a first diameter and the outer flow path is a second diameter. Further, the dual entry turbine 46 may include a first nozzle configured to accelerate the first medium for entry into a turbine impeller and a second nozzle configured to accelerate the second medium for entry into the turbine impeller. The turbine impeller can be configured with a first gas path configured to receive the first medium A1 from the first nozzle and with a second gas path configured to receive the second medium A2 from the second nozzle.

A compressor 42 is a mechanical device configured to raise a pressure of a medium and can be driven by another mechanical device (e.g., a motor or a medium via a turbine). Examples of compressor types include centrifugal, diagonal or mixed-flow, axial-flow, reciprocating, ionic liquid piston, rotary screw, rotary vane, scroll, diaphragm, air bubble, etc. A turbine, such as any of turbines 46, 48 for example, is a mechanical device that expands a medium and extracts work therefrom (also referred to as extracting energy) to drive the compressor 42 via the shaft 44.

The fan 50 is a mechanical device that can force, via push or pull methods, a medium (e.g., ram air) across the one or more heat exchangers 34, 36 and at a variable cooling to control temperatures.

The ECS 20 may additionally include at least one dehumidification system 52. In the illustrated, non-limiting embodiment of FIGS. 1-4, the dehumidification system 52 includes a heat exchanger 54, such as a condenser for example, and a water extractor 56. The condenser 54 is a particular type of heat exchanger and the water extractor 56 is a mechanical device that removes water from a medium. The dehumidification system 52 is arranged to receive the second medium A2, and in some embodiments, both the first medium A1 and the second medium A2. However, the configuration of the at least one dehumidification system 52 may vary.

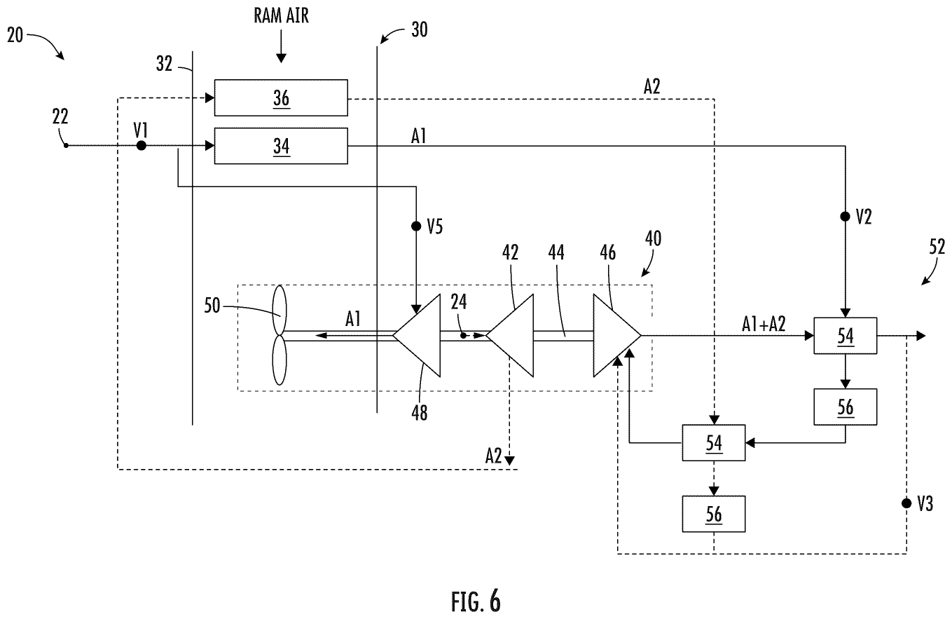

With reference to FIG. 5, in the illustrated, non-limiting embodiment, in addition to the condenser 54 and the water extractor 56, the dehumidification system 52 includes another condenser 58 and water extractor 60. The condenser 54 and water extractor 56, in combination, may be associated with a flow of the second medium A2 and the condenser 58 and water extractor 60, in combination, may be associated with a flow of the first medium A1. Further, the condensers 54, 58 may also be associated with a flow of a mixture of the first and second mediums A1+A2. In another embodiment, illustrated in FIG. 6, the dehumidification system 52 includes a heat exchanger, 54, water extractor 56, another heat exchanger 62 and water extractor 64. In the illustrated, non-limiting embodiment, the heat exchanger 62 is a condenser, and the heat exchanger 54 is a reheater and the condenser 62, water extractor 64, and reheater 54 are arranged in series relative to a flow of the first medium A1. It should be understood that the disclosed configuration of the dehumidification system is intended as an example only, and embodiments including one or more additional components are also within the scope of the disclosure.

The elements of the ECS 20 are connected via valves, tubes, pipes, and the like. Valves (e.g., flow regulation device or mass flow valve) are devices that regulate, direct, and/or control a flow of a medium by opening, closing, or partially obstructing various passageways within the tubes, pipes, etc. of the system. Valves can be operated by actuators, such that flow rates of the medium in any portion of the system can be regulated to a desired value. For instance, in the non-limiting embodiment shown in FIGS. 1-4, a first valve V1 is configured to control a supply of the second medium A1 provided to the ECS 20. A second valve V2 may be operable to control a flow of one of the plurality of mediums, such as the first medium output from the primary heat exchanger 34 for example, to the dual entry turbine 46. A third valve V3 may be associated with a bypass conduit and operable to allow a flow of the second medium to bypass one of the turbines, such as the dual entry turbine 46 via a bypass conduit. A fourth valve V4 may be operable to provide surge control of the compressor 42 and a fifth valve may be operable to control a flow of a first medium to the second turbine 48.

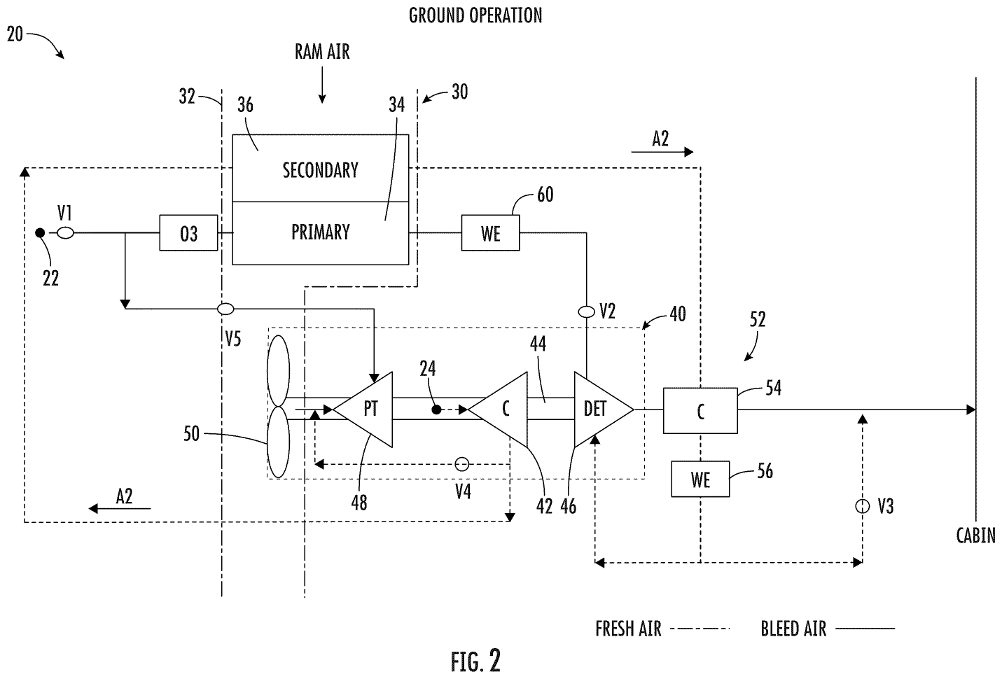

The environmental control system of FIG. 1 may be operable in a plurality of modes based on a flight condition of the aircraft. For example, the ECS may be operable in a first mode or “ground mode” for ground and low altitude flight conditions such as ground idle, taxi, take-off, and hold conditions. An example of the ECS in a ground mode is illustrated in FIG. 2. As shown, the high-pressure high-temperature first medium A1 is provided from the first inlet 22 to the primary heat exchanger 34 of the ram air circuit 30. The primary heat exchanger 34 cools the first medium A1 to nearly ambient temperature. The temperature of the first medium A1 exiting the heat exchanger 34 is low enough to condense moisture from the first medium A1. The first medium A1 then enters a water extractor 60 where the moisture in the air is removed. The resulting cool, dry high pressure first medium A1 enters the turbine 46 through a nozzle, where it is expanded and work extracted. The work from the turbine 46 drives the compressor 42 which is used to compress the second medium A2 and drives a fan 50 used to move air through the ram air duct 32. The act of compressing the second medium A2 heats it. The compressed second medium A2 enters the secondary heat exchanger 36. The second medium A2 is cooled to nearly ambient temperature. This cool, medium pressure second medium A2 enters the condenser 54, where it is cooled by a flow output from the turbine 46. The second medium A2 then enters the water extractor 56 where any free moisture in the second medium A2 is removed. This cool dry second medium A2 then enters the turbine 46 through a second nozzle, where it is expanded and work extracted. The two flows of the first medium A1 and the second medium A2 are mixed at the turbine exit. The mixed medium A1+A2 leaves the turbine 46 and cools the second medium A2 leaving the secondary heat exchanger 36 in the condenser 54. The mixed medium A1+A2 is then sent to one or more loads. In an embodiment, the mixed medium A1+A2 is used to condition the cabin and flight deck. In the ground mode, the energy used to drive the thermodynamic device 40 may be extracted solely at the first turbine 46, such as from both the first and second mediums A1, A2.

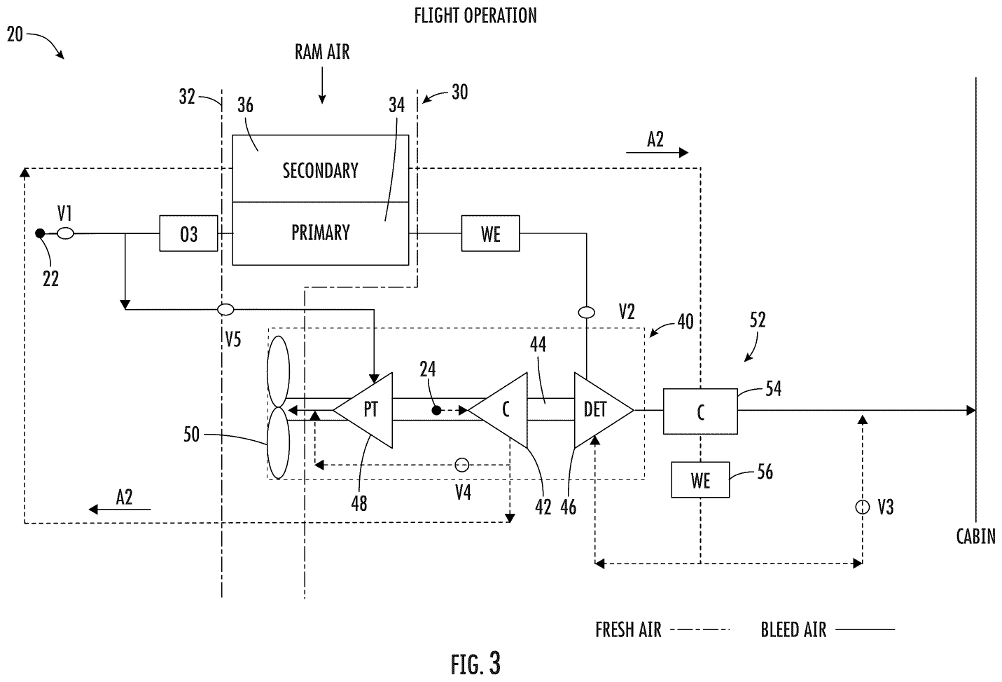

Another mode of operation of the ECS is a “high-altitude” operation, shown in FIG. 3. The second mode or high-altitude mode would be used for flight conditions such as at high altitude cruise, climb, and descent flight conditions. In the high-altitude mode, the second valve V2 is closed and the fifth valve V5 is open. As a result, the first medium A1 bypasses the ram air circuit 30 and is provided to an inlet of the second turbine 48. The first medium A1 enters the turbine 48 through a nozzle, where it is expanded and work extracted. The work extracted within the second turbine 48 drives the compressor 42 used to compress the second medium. From the second turbine, the first medium is exhausted into the ram air circuit, such as at a location downstream from the heat exchangers 34, 36. The second medium A2 provided to the compressor 42 from the second inlet 24 is heated within the compressor. The compressed second medium A2 then enters the secondary heat exchanger 36 and is cooled to nearly ambient temperature. In the high-altitude mode, the third valve V3 is open. Accordingly, neither the first medium A1 nor the second medium A2 is provided to the first turbine 46. Therefore, the energy used to drive the thermodynamic device 40 in the high-altitude mode of operation is extracted solely at the first turbine 46, such as from the first medium A1.

The cool second medium A2 output from the secondary heat exchanger 36 passes through the condenser 54 and the water extractor 56 and is then provided to one or more loads, such as the flight deck and the cabin. In the high-altitude mode, the power used to drive the compressor is only provided from the second turbine 48 and the energy extracted from the first medium A1 therein.

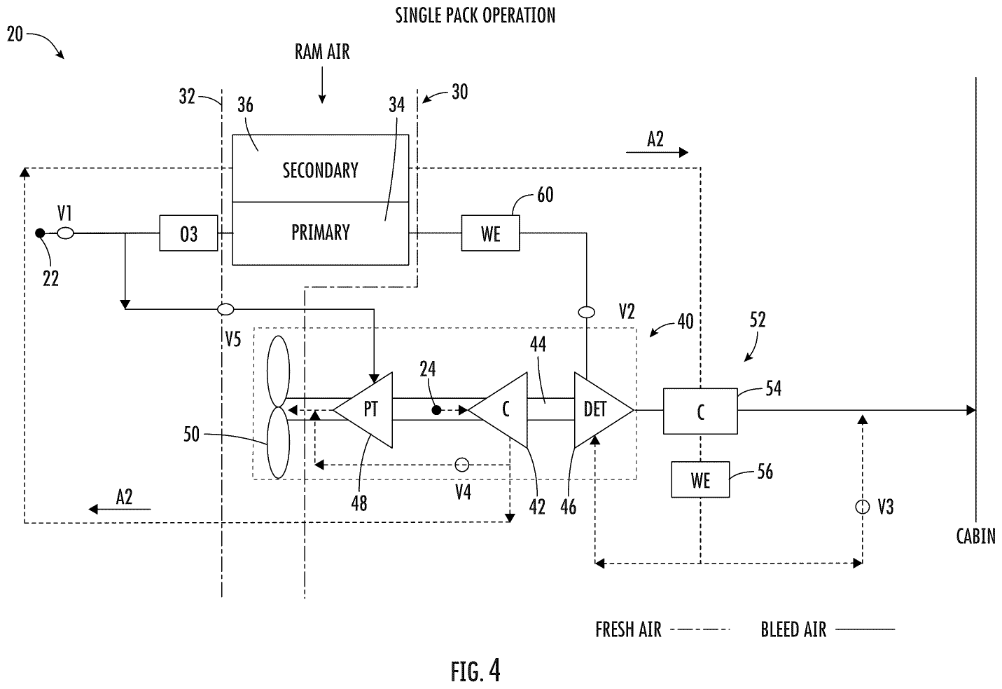

In the event of a failure of a pressurized air system and/or of an ECS pack 20, a remaining functional ECS pack may be configured to meet the demands of the aircraft. To maintain the pressure and/or flow rate requirements associated with operation in such a failure mode, the remaining operational ECS or ECS pack may be operated in a “single pack” mode of operation. With reference to FIG. 4, operation in the single pack mode is similar to operation in the high-altitude mode in that at least a portion Ala of the first medium A1 bypasses the ram air circuit 30 and is provided to the second turbine 48. However, valve V2 is open to meet the cabin inflow requirement and provide power to the compressor 42. Accordingly, a second portion Alb of the first medium is provided to the turbine 46 and work is extracted therefrom. In the single pack mode, the compressed second medium A2 output from the heat exchanger 36 will be cooled in the condenser 54 via the flow output from the turbine 46 and any free moisture in the second medium A2 will be removed within the water extractor 56.

Depending on the flight condition of the aircraft during the single pack mode, this cool dry flow of the second medium A2 may be provided to the turbine 46 or alternatively, may bypass the turbine 46. If the second medium A2 is provided to the turbine 46, the work is extracted from the second medium A2 within the turbine 46. Further, the two flows of the first medium A1 and the second medium A2 are mixed at the turbine exit. The mixed medium A1+A2 leaves the turbine 46 and cools the second medium A2 leaving the secondary heat exchanger 36 in the condenser 54. The mixed medium A1+A2 is then sent to one or more loads. In embodiments where the second medium A2 bypasses the turbine 46, the second medium A2 mixes with the second portion Alb of the first medium output from the turbine 46 and warmed within the condenser 54. The mixed medium Alb+A2 is then provided to one or more loads.

With reference now to the ECS 20 illustrated in FIG. 5, during operation in a ground mode, the high-pressure high-temperature first medium A1 is provided from the first inlet 22 to the primary heat exchanger 34 of the ram air circuit 30. The first medium A1 is cooled within the primary heat exchanger 34 by a flow of ram air to a nearly ambient temperature. The temperature of the first medium A1 exiting the heat exchanger 34 may be low enough to condense moisture from the first medium A1. In some embodiments, the first medium A1 output from the primary heat exchanger 34 is provided to a condenser 58 the first medium A1 is cooled by a flow output from the turbine 46 and the condenser 54. The first medium A1 then enters a water extractor 60 where the moisture in the air is removed. The resulting cool, dry high pressure first medium A1 enters the turbine 46 through a nozzle, where it is expanded and work extracted. The work extracted from the first medium A1 at the turbine 46 is used to compress the second medium A2 at the compressor 42 and drive the fan 50 to move ram air through the ram air duct 32.

From the second inlet 24, a flow of second medium A2 is provided to the compressor 42. The act of compressing the second medium A2 heats it. The compressed second medium A2 enters the downstream secondary heat exchanger 36. The second medium A2 may be cooled to nearly ambient temperature within the secondary heat exchanger 36. This cool, medium pressure second medium A2 enters the condenser 54, where it is cooled by a flow output from the turbine 46. The second medium A2 then enters the water extractor 56 where any free moisture in the second medium A2 is removed. This cool dry second medium A2 then enters the turbine 46 through a second nozzle, where it is expanded and work is extracted therefrom. The work extracted from the second medium A2 at the turbine 46 may also be used to drive the compressor 42 and the fan 50. The flow of the first medium A1 and the flow of the second medium A2 are mixed at the outlet of the turbine 46 to form a mixed medium A1+A2. From the outlet of the turbine, the mixed medium A1+A2 is provided to the condenser 54 where it absorbs heat from the second medium A2 leaving the secondary heat exchanger 36. The mixed medium A1+A2 is then provided to the condenser 58 where the mixed medium A1+A2 absorbs additional heat from the first medium A1 output from the primary heat exchanger 34. Downstream from the condenser 58, the mixed medium A1+A2 is delivered to one or more loads, such as the cabin and flight deck.

Similar to the embodiment shown in FIG. 2, when the ECS 20 of FIG. 5 is operated in a high-altitude mode, valve V5 may be opened and valve V2 may be closed such that the entire flow of first medium A1 is delivered to the second turbine 48. The energy extracted from the first medium A1 at the second turbine 48 may be used to drive the thermodynamic device 40 by rotating the shaft 44 thereof. This driving of the thermodynamic device 40 includes driving the compressor 42 and the fan 50. Further, the valve V3 may be open such that the flow of the second medium A2 output from the dehumidification system 52 bypasses the turbine 46 and is provided to one or more loads.

Operation of the ECS 20 of FIG. 6 in a ground mode is similar to the ECS 20 of FIG. 5. The high-pressure high-temperature first medium A1 is provided from the first inlet 22 to the primary heat exchanger 34 of the ram air circuit 30. The first medium A1 is cooled within the primary heat exchanger 34 by a flow of ram air to a nearly ambient temperature. The temperature of the first medium A1 exiting the heat exchanger 34 may be low enough to condense moisture from the first medium A1. In some embodiments, the first medium A1 output from the primary heat exchanger 34 is provided to a condenser 62 where the first medium A1 is cooled by a flow output from the turbine 46. The first medium A1 then enters the water extractor 64 where the moisture in the air is removed. The resulting cool, dry high pressure first medium A1 is then heated within the reheater 54 by the second medium A2 output from the secondary heat exchanger 36. The warm, dry first medium A1 enters the turbine 46 through a nozzle, where it is expanded and work is extracted therefrom. The work extracted from the first medium A1 at the turbine 46 is used to compress the second medium A2 at the compressor 42 and drive the fan 50 to move ram air through the ram air duct 32.

From the second inlet 24, a flow of second medium A2 is provided to the compressor 42. The act of compressing the second medium A2 heats it. The compressed second medium A2 enters the downstream secondary heat exchanger 36. The second medium A2 may be cooled to nearly ambient temperature within the secondary heat exchanger 36. This cool, medium pressure second medium A2 enters the reheater 54, where it is cooled by the flow of first medium A1 output from the water extractor 64. The second medium A2 then enters the water extractor 56 where any free moisture in the second medium A2 is removed. This cool dry second medium A2 then enters the turbine 46 through a second nozzle, where it is expanded and work is extracted therefrom. The work extracted from the second medium A2 at the turbine 46 may also be used to drive the compressor 42 and the fan 50. The flow of the first medium A1 and the flow of the second medium A2 are mixed at the outlet of the turbine 46 to form a mixed medium A1+A2. From the outlet of the turbine 46, the mixed medium A1+A2 is provided to the condenser 62 where it absorbs heat from the first medium A1 output from the primary heat exchanger 34. Downstream from the condenser 62, the mixed medium A1+A2 is delivered to one or more loads, such as the cabin and flight deck.

Similar to the embodiment shown in FIGS. 2 and 5, when the ECS 20 of FIG. 6 is operated in a high-altitude mode, valve V5 may be opened and valve V2 may be closed such that the entire flow of first medium A1 is delivered to the second turbine 48. The energy extracted from the first medium A1 at the second turbine 48 may be used to drive the thermodynamic device 40 by rotating the shaft 44 thereof. This driving of the thermodynamic device 40 includes driving the compressor 42 and the fan 50. Further, the valve V3 may be open such that the flow of the second medium A2 output from the dehumidification system 52 bypasses the turbine 46 and is provided directly to one or more loads.

An ECS 20 as illustrated and described herein does not rely on power drawn from a flow of air exhausted from the cabin to drive the thermodynamic device 40 in at least one mode of operation, such as when the aircraft is in a high-flight mode. Rather, only the first medium A1, which may be high pressure air bled from an engine of the aircraft may be used to drive the thermodynamic device 40 in one or more modes of operation.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An environmental control system of a vehicle comprising:
a first inlet for providing a first medium;
a second inlet for providing a second medium, the second medium being different than the first medium;
a thermodynamic device including a compressor and at least one turbine operably coupled by a shaft, the thermodynamic device being fluidly connected to both the first inlet and the second inlet; and
wherein the environmental control system is operable in a plurality of modes, and in a first mode of the plurality of modes, the thermodynamic device is driven solely by energy extracted from the first medium.

2. The environmental control system of claim 1, wherein the compressor is fluidly connected to and arranged downstream from the second inlet.

3. The environmental control system of claim 1, wherein the first medium is bleed air.

4. The environmental control system of claim 1, wherein the second medium is fresh air.

5. The environmental control system of claim 1, wherein the thermodynamic device further comprises a fan operably coupled to the shaft and in the first mode, the compressor and the fan are driven by the energy extracted from the first medium.

6. The environmental control system of claim 1, wherein the at least one turbine includes a first turbine and a second turbine, the first turbine being fluidly coupled to both the first inlet and the second inlet and the second turbine being fluidly connected to the first inlet.

7. The environmental control system of claim 6, wherein the first turbine is arranged downstream from the compressor relative to a flow of the second medium.

8. The environmental control system of claim 6, further comprising:
a first valve operable to direct a flow of the first medium from an outlet of the first inlet toward either the first turbine or the second turbine; and
a second valve operable to direct a flow of the second medium into a bypass conduit positioned to bypass the first turbine.

9. The environmental control system of claim 1, wherein in the first mode, only the second medium is provided to an outlet of the environmental control system.

10. The environmental control system of claim 1, further comprising a ram air circuit having a ram air duct and at least one heat exchanger arranged within the ram air duct.

11. The environmental control system of claim 10, wherein the at least one heat exchanger includes a first heat exchanger and a second heat exchanger, the first heat exchanger and the second heat exchanger being arranged in series relative to a flow of ram air within the ram air duct.

12. The environmental control system of claim 10, wherein the at least one heat exchanger includes a first heat exchanger and a second heat exchanger, the first heat exchanger and the second heat exchanger being arranged in parallel relative to a flow of ram air within the ram air duct.

13. An environmental control system of a vehicle comprising:
a first inlet for providing a first medium;
a second inlet for providing a second medium, the second medium being different than the first medium;
a thermodynamic device including a compressor, a first turbine, and a second turbine operably coupled by a shaft, the thermodynamic device being fluidly connected to both the first inlet and the second inlet; and
wherein the environmental control system is operable in a first mode and a second mode, and in the first mode, the thermodynamic device is driven solely by energy extracted at the first turbine and in the second mode, the thermodynamic device is driven solely by energy extracted at the second turbine.

14. The environmental control system of claim 13, wherein the first medium is bleed air and the second medium is fresh air.

15. The environmental control system of claim 13, wherein in the first mode, the thermodynamic device is driven by the energy extracted from the first medium and the second medium at the first turbine.

16. The environmental control system of claim 13, wherein in the second mode, the thermodynamic device is driven by the energy extracted from the first medium at the second turbine.

17. A method of operating an environmental control system of an aircraft comprising:
providing a first medium and a second medium to a thermodynamic device including a compressor and at least one turbine;
in a first mode of operation:
extracting work from the first medium at the at least one turbine; and
compressing the second medium at the compressor, wherein in at least one mode of operation, the compressor is driven only by work extracted from the first medium at the at least one turbine.

18. The method of claim 17, wherein in a second mode of operation, extracting work from the first medium and the second medium at the at least one turbine.

19. The method of claim 18, wherein the at least one turbine includes a first turbine and a second turbine, wherein in the first mode of operation, extracting work from the first medium at the first turbine and in the second mode of operation, extracting work from the first medium and the second medium at the second turbine.

20. The method of claim 17, wherein the first medium is bleed air and the second medium is fresh air.
